(19) United States
(12) Patent Application Publication
(10) Pub. No.: US 2026/0345435 A1
(43) Pub. Date: Nov. 5, 2026

(54) VEHICLE HAPTIC SYSTEM

(71) Applicant: Jaguar Land Rover Limited, Coventry, Warwickshire (GB)

(72) Inventors: Paul WILES, Coventry (GB); Jordan ROONEY, Coventry (GB); Sofie SHACKCLOTH, Coventry (GB); Jamal HAMEEDI, Coventry (GB); William PAYRE, Coventry (GB); Susanne GRUNEWALD, Coventry (GB)

(21) Appl. No.: 19/484,723

(22) PCT Filed: May 2, 2024
(86) PCT No.: PCT/EP2024/062029

§ 371 Date: Nov. 14, 2025

(30) Foreign Application Priority Data
May 15, 2023 (GB) 2307172.3

(51) Int. Cl. A61H 23/02; B60N 2/90

(52) U.S. Cl. CPC A61H 23/0236; B60N 2/976; A61H 2201/0149; A61H 2201/1623; A61H 2201/5002; A61H 2201/5005

(57) ABSTRACT

Aspects of the present invention relate to a vehicle haptic system for vibrating a body part of an occupant of a vehicle, the vehicle haptic system comprising at least one audio speaker for converting an audio signal to sound waves; at least one haptic transducer for generating a vibration according to a haptic signal; a memory storing at least one media track comprising at least one audio signal to drive the at least one audio speaker; and at least one haptic signal to drive the at least one haptic transducer; a control system in communication with the at least one audio speaker and the at least one haptic transducer, and configured to cause the at least one audio speaker to convert the at least one audio signal to sound waves, and cause the at least one haptic transducer to vibrate according to the at least one haptic signal.

### TECHNICAL FIELD

The present disclosure relates to a vehicle haptic system. Aspects of the invention relate to a vehicle haptic system, and to a method of controlling a vehicle haptic system.

### BACKGROUND

It is widely known that occupants of vehicles enjoy listening to music during a journey. To counter feelings of tiredness or fatigue, and stimulate the brain, drivers often play music from a stereo system of the automobile. Stereo systems in automobiles are typically embedded within the panelling of a vehicle, for example in the door panels, in order to propagate sound effectively within a vehicle. The music played may invoke a feeling of excitement or relaxation, depending on the genre, tempo etc of the music. Research has shown that acoustic vibrations, as emitted from a stereo speaker for example, may be used in a type of therapy called vibro-acoustic therapy (VAT). Vibro-acoustic therapy is typically defined as a therapy that uses low frequency vibrations, anywhere in the range of 20 to 200 Hz, to stimulate a patient with a massaging sensation, and thereby increase circulation of blood throughout the body. Specific frequencies within this range may be used to target localised areas of the body, such as the lower back or the shoulders. The vibrations emitted during vibro-acoustic therapy, differ from mechanical vibrations (as induced by driving over a rough surface, for example) in that mechanical vibrations result in numbness, muscle contraction, and fatigue, whereas those used in vibro-acoustic therapy do not. The benefits of vibro-acoustic therapy are cited to include muscle relaxation, pain inhibition, improved cognitive ability, and enhanced wellbeing.

It is an object of the invention to improve the comfort and wellbeing of occupants of a vehicle.

### SUMMARY OF THE INVENTION

According to an aspect of the present invention there is provided a vehicle haptic system for vibrating a body part of an occupant of a vehicle, the vehicle haptic system comprising:
at least one audio speaker for converting an audio signal to sound waves;
at least one haptic transducer for generating a vibration according to a haptic signal;
a memory storing at least one media track, the at least one media track comprising:
   at least one audio signal to drive the at least one audio speaker; and
   at least one haptic signal to drive the at least one haptic transducer;
a control system in communication with the at least one audio speaker and the at least one haptic transducer, and configured to cause the at least one audio speaker to convert the at least one audio signal to sound waves, and cause the at least one haptic transducer to vibrate according to the at least one haptic signal.

Advantageously, the provision of both audio and haptic stimuli to a user of a vehicle allows the benefits of vibro-acoustic therapy, including muscle relaxation, pain inhibition, improved cognitive ability, and enhanced wellbeing, to be realised within the vehicle.

In an embodiment, the at least one haptic signal of the at least one media track comprises at least one repeating pattern of at least one pulse.

Advantageously, the use of repeating patterns of at least one non-static pulse within the haptic signals has been found to stimulate a user, without providing a distraction. That is, using a repeating pattern (rather than a single, regular, repeating pulse) provides variation that avoids monotony and induces boredom. However, the use of repetition ensures the user is not distracted. As such, the occupant receives an improved audio and massage experience, without detriment to the occupants concentration or cognitive ability.

In an embodiment, the at least one haptic signal of the at least one media track comprises a first repeating pattern of at least one pulse followed by a second repeating pattern of at least one pulse.

Advantageously, the use of multiple repeating patterns has been found to help ensure the media track does not feel too repetitive or monotonous to a user. That is, the change from a first repeating pattern to another repeating pattern provides additional stimulus to a user, which may be beneficial at a time when the users interest in the first repeating pattern is decreasing.

In an embodiment, the first repeating pattern of at least one pulse differs from the second repeating pattern of at least one pulse in at least one of:
the shape of the at least one pulse;
the frequency of the at least one pulse;
the amplitude of the at least one pulse;
the timing of the at least one pulse; and
the time between successive pulses.

In an embodiment, the tempo of the at least one audio signal of the at least one media track is the same as, or linked to, the tempo of the at least one haptic signal of the at least one media track.

Advantageously, providing similarities in the signal characteristics (for example tempo, rhythm, beat) of the audio and haptic signals has been found to help ensure the audio and haptic stimuli work in concert. That is, the haptic sensations compliment the audio stimulus so that the media track provides a single, but multi-faceted, experience to the user. This ensures the media track is not distracting to a user and they instead feel immersed within the track.

In an embodiment, the at least one audio signal of each media track corresponds to a music track.

In an embodiment, the at least one haptic signal of the at least one media track comprises a first haptic signal to drive a first haptic transducer of the at least one haptic transducer and a second haptic signal to drive a second haptic transducer of the at least one haptic transducer.

In an embodiment, the first haptic signal comprises a frequency range of from 60 to 150 Hz, and the second haptic signal comprises a frequency range of from 25 to 70 Hz.

Advantageously, the spine of an occupant has been found to be particularly receptive to vibrations in the frequency range of from 60 to 150 Hz, maximising the massage sensation. Advantageously, the kidneys of an occupant have been found to be particularly receptive to vibrations in the frequency range of from 25 to 70 Hz, maximising the massage sensation.

In an embodiment, the first haptic signal comprises at least one repeating pattern of at least one pulse, and wherein the second haptic signal comprises at least one repeating pattern of at least one pulse, wherein, at a corresponding time for each of the first haptic signal and the second haptic signal, the at least one repeating pattern of at least one pulse of the first haptic signal differs from the at least one repeating pattern of at least one pulse of the second haptic signal in at least one of:
the shape of the at least one pulse;
the frequency of the at least one pulse;
the amplitude of the at least one pulse;
the timing of the at least one pulse; and
the spacing between successive pulses.

In an embodiment, the vehicle haptic system comprises at least one sensor arrangement configured to measure physiological parameters regarding a user of the vehicle haptic system and generate a sensor signal, and
wherein the control system is configured to receive the sensor signal from the at least one sensor arrangement.

In an embodiment, the at least one sensor arrangement comprises one or more of a heart rate sensor and a galvanic skin response sensor.

In an embodiment, in response to the sensor signal indicating a physiological parameter of the user of the vehicle haptic system is above an upper threshold or below a lower threshold, the control system is configured to adjust the at least one audio signal and/or the at least one haptic signal.

In an embodiment, in response to the sensor signal indicating a physiological parameter of the user of the vehicle haptic system is above an upper threshold or below a lower threshold, the control system is configured to retrieve another media track of the plurality of media tracks from the memory.

In an embodiment, in response to the sensor signal indicating a physiological parameter of the user of the vehicle haptic system is above an upper threshold or below a lower threshold, the control system is configured to send a notification signal to a user interface of the vehicle haptic system, the notification signal suggesting the selection of another media track of the plurality of media tracks from the memory.

Informing the control system or user of the users physiological parameters allows the choice of track, or the characteristics of a particular track to be based on the needs of the user.

In an embodiment, the vehicle haptic system comprises at least one of a lighting system and a fragrance system,
wherein each media track comprises at least one actuation signal, and
wherein the control system is configured to actuate the at least one of a lighting system and a fragrance system according to the at least one actuation signal of each media track.

In an embodiment, the memory is storing a plurality of media tracks, each of the plurality of media tracks comprising:
at least one audio signal to drive the at least one audio speaker; and
at least one haptic signal to drive the at least one haptic transducer,
wherein the vehicle haptic system comprises input means for receiving an input from a user of the vehicle haptic system,
wherein on receiving an input from a user of the vehicle haptic system, the input means is configured to send an input signal to the control system,
wherein on receiving an input signal from the input means selecting a media track of the plurality of media tracks, the control system is configured to retrieve the selected media track from the memory.

Advantageously, the user is provided with a library of tracks that may each invoke a different physiological response from the resulting stimulus. As such, a user can choose to change or reinforce their state or mood.

In an embodiment, a first media track of the plurality of media tracks comprises a first tempo and a second media track of the plurality of media tracks comprises a second tempo.

Advantageously a higher tempo track may be used to invigorate a user, whereas a lower tempo track may be used to relax a user. In this sense, the mood of a user may be changed or reinforced depending on the chosen track.

In an embodiment, on receiving an input signal from the input means, the control system is configured to adjust the at least one audio signal and/or the at least one haptic signal. Advantageously, this allows the user to adjust the output of the media track to suit personal preference.

In an embodiment, the vehicle haptic system comprises at least one vehicle seat comprising a backrest portion for supporting the user of the vehicle haptic system, wherein the at last one haptic transducer is disposed on the backrest portion.

In an embodiment, the at least one haptic transducer comprises:
a first set of at least one haptic transducer disposed along a central, longitudinal, axis of the backrest portion; and
a second set of at least one haptic transducer disposed in a position laterally offset from the central, longitudinal, axis of the backrest portion.

Advantageously, the haptic transducers are spaced apart so as to target different areas of the back (e.g., a spine, kidneys) of an occupant of the at least one vehicle seat. Further, each haptic transducer may receive a different haptic signal, thereby providing a different massage sensation to different areas of the back of an occupant of the at least one vehicle seat.

In an embodiment, the at least one haptic transducer of the first set is positioned so as to vibrate a spinal region of the user of the vehicle haptic system, in use, and
wherein the at least one haptic transducer of the second set is positioned so as to vibrate a kidney region of the user of the vehicle haptic system, in use.

In an embodiment, the control system is configured to independently control the at least one haptic transducer of the first set and the at least one haptic transducer of the second set.

In an embodiment, the vehicle haptic system comprises at least one foot haptic module for positioning in a footrest or floor portion of a vehicle, the at least one foot haptic module comprising the at least one haptic transducer.

In an embodiment, the at least one haptic transducer comprises:
a first set of at least one haptic transducer for vibrating a first foot of the user of the vehicle haptic system; and
a second set of at least one haptic transducer for vibrating a second foot of the user of the vehicle haptic system.

In an embodiment, the at least one foot haptic module comprises a profile having a length and a width, wherein the first set of at least one haptic transducer is offset from the second set of at least one haptic transducer along the length and/or the width of the profile of the at least one foot haptic module.

In an embodiment, the first haptic transducer of the plurality of haptic transducers is configured to receive a first haptic signal of the at least one haptic signal and the second haptic transducer of the plurality of haptic transducers is configured to receive a second haptic signal of the at least one haptic signal, separate from the first haptic signal.

In an embodiment, the control system is configured to independently control the at least one haptic transducer of the first set and the at least one haptic transducer of the second set.

According to another aspect of the present invention there is provided a vehicle comprising the vehicle haptic system of any embodiment described herein.

In a further aspect according to the present invention, there is provided a method of controlling the vehicle haptic system any preceding described herein, the method comprising:
causing the at least one audio speaker of the vehicle haptic system to convert the at least one audio signal to sound waves, and causing the at least one haptic transducer of the vehicle haptic system to vibrate according to the at least one haptic signal.

In a yet further aspect according to the present invention, there is provided a method of controlling a vehicle haptic system, the method comprising:
in response to receiving an input signal selecting a media track of a plurality of media tracks stored in a memory of the vehicle haptic system, retrieving the selected media track from the memory, wherein each media track comprises at least one audio signal and at least one haptic signal; and
causing at least one audio speaker of the vehicle haptic system to convert the at least one audio signal to sound waves, and causing at least one haptic transducer of the vehicle haptic system to vibrate according to the at least one haptic signal.

In a yet further aspect of the invention there is provided computer readable instructions which, when executed by a computer, are arranged to perform a method according to any aspect of the invention described herein.

In a yet further aspect of the invention there is provided a non-transitory, computer-readable storage medium storing instructions thereon that, when executed by one or more electronic processors, causes the one or more electronic processors to carry out a method according any aspect of the invention described herein.

Within the scope of this application it is expressly intended that the various aspects, embodiments, examples and alternatives set out in the preceding paragraphs, in the claims and/or in the following description and drawings, and in particular the individual features thereof, may be taken independently or in any combination. That is, all embodiments and/or features of any embodiment can be combined in any way and/or combination, unless such features are incompatible. The applicant reserves the right to change any originally filed claim or file any new claim accordingly, including the right to amend any originally filed claim to depend from and/or incorporate any feature of any other claim although not originally claimed in that manner.

### BRIEF DESCRIPTION OF THE DRAWINGS

One or more embodiments of the invention will now be described, by way of example only, with reference to the accompanying drawings, in which:

FIG. 1 shows a schematic representation of a vehicle haptic system;

FIG. 2 shows examples of haptic signals for a vehicle haptic system;

FIG. 3 shows a vehicle in accordance with an embodiment of the invention;

FIG. 4 shows an illustration of a vehicle seat in accordance with an embodiment of the invention;

FIG. 5 shows a further illustration of the vehicle seat of FIG. 4 in accordance with an embodiment of the invention;

FIG. 6 shows an exploded view of the vehicle seat of FIG. 4 in accordance with an embodiment of the invention;

FIG. 7 shows a further illustration of the vehicle seat of FIG. 4 in accordance with an embodiment of the invention;

FIG. 8 shows a schematic representation of a vehicle haptic system;

FIGS. 9 to 11 show examples of haptic signals for a vehicle haptic system; and

FIG. 12 shows an example control system for use in a vehicle haptic system.

### DETAILED DESCRIPTION

A vehicle haptic system in accordance with an embodiment of the present invention is described herein with reference to the accompanying Figures.

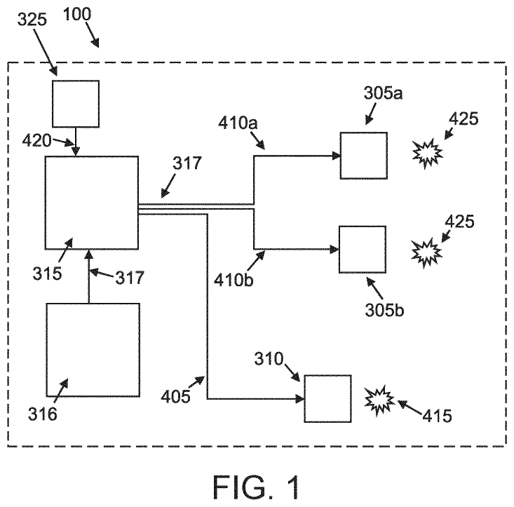

Turning first to FIG. 1, a vehicle haptic system 100 is shown. The vehicle haptic system 100 includes at least one audio speaker 310 for converting an audio signal 405 to sound waves 415. The at least audio speaker 310 may include a loudspeaker, headphones, earphones, or other types of audio speaker known in the art. The audio speaker 310 may be disposed within door panelling or within a vehicle seat, for example. When disposed on a vehicle seat, the audio speaker 310 may be affixed to a mounting frame. In the example of FIG. 1, the at least one audio speaker includes a single audio speaker 310. However, in other examples there may be any number of audio speakers, for example two, three or more within the vehicle haptic system 10.

The vehicle haptic system 100 includes at least one haptic transducer for generating a vibration according to a haptic signal. In the example of FIG. 1, the at least one haptic transducer includes two haptic transducers 305a, 305b. However, in other examples there may be any number of haptic transducers, for example one, three or more. The haptic transducers 305a, 305b may include, for example, vibrators or shakers, which are configured to generate a vibration in response to a haptic signal. The plurality of haptic transducers 305a, 305b are configured to produce vibrations of low, or bass, frequencies, typically in the range of 20 Hz to 200 Hz. The vibrations produced by the haptic transducers 305a, 305b in response to a haptic signal may otherwise be referred to as haptic vibrations or tactile vibrations. As will be explained further below, the vehicle haptic system 100 is configured so that the vibrations produced by the plurality of haptic transducers 305a, 305b provide haptic or tactile feedback to the occupant 2000.

The vehicle haptic system 100 includes a control system 315 and a memory 316 storing at least one media track 317.

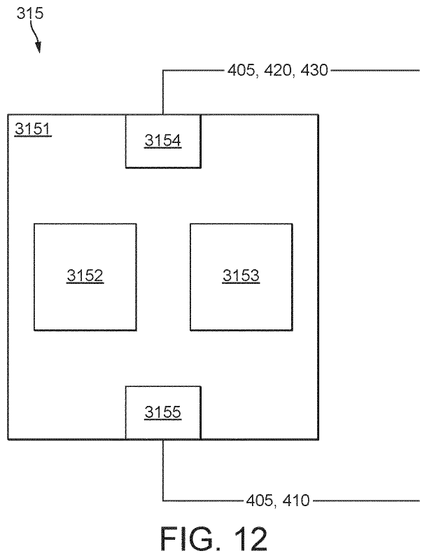

In the example of FIG. 1, the memory 316 is separate or external to the control system 315, for example an external storage device or cloud storage. In such examples, the control system 315 is in communication with the memory 316. The communication may be via an internet connection or a physical wired connection. In other examples the memory 316 may be internal storage within the control system 315, for example as shown in the example of FIG. 12.

Referring to a single media track 317, the media track 317 includes at least one audio signal 405 to drive the audio speaker 310. The audio signal 405 may include, for example a music track. The music track may include any number of musical instruments and musical elements, for example one or more synthesisers, bass, drums, percussion, nature or every day sounds, etc.

The media track 317 also includes a haptic signal 410a, 410b to drive each haptic transducer 305a, 305b. As used herein, a haptic signal is a signal generated for the purpose of actuating a haptic transducer—in this example the haptic transducers 305a, 305b.

The control system 315 is in communication with the audio speaker 310 and the haptic transducers 305a, 305b. This communication may be a physical or wireless coupling by any means known in the art, either directly or indirectly.

The control system 315 is configured to cause the audio speaker 310 to convert the audio signal 405 to sound waves 415, for example so as to be audible to one or more occupants of a vehicle. The control system 315 is also configured to cause the haptic transducers 305a, 305b to vibrate according to the haptic signals 410a, 410b. The control system 315 may be located proximate to a centre console, dashboard, media player, or navigation system, of the vehicle 1000. Alternatively, the control system 315 may be located within the at least one vehicle seat 105. The control system 315 may be coupled to the audio speaker 310 and the haptic transducers 305a, 305b by any means known in the art, either directly or indirectly.

In use, for example in response to an input from a user of the vehicle haptic system 100 to play the media track 317, the control system 315 retrieves the media track from the memory 316 and sends the audio signal 405 to the audio speaker 310 and sends the haptic signals 410a, 410b to the haptic transducers 305a, 305b. The audio speaker 310 converts the audio signal 405 to sound waves 415 simultaneously with the haptic transducers 305a, 305b converting the haptic signals 410a, 410b to vibrations. That is, the signals are played together to output the media track in its entirety (that is, to output all signals of the media track) at a given time.

Advantageously, the provision of both audio and haptic stimuli to a user of a vehicle haptic system allows the benefits of vibro-acoustic therapy, including improved cognitive ability, and enhanced wellbeing, to be realised within a vehicle. Improved cognitive ability is particularly advantageous for the driver of the vehicle.

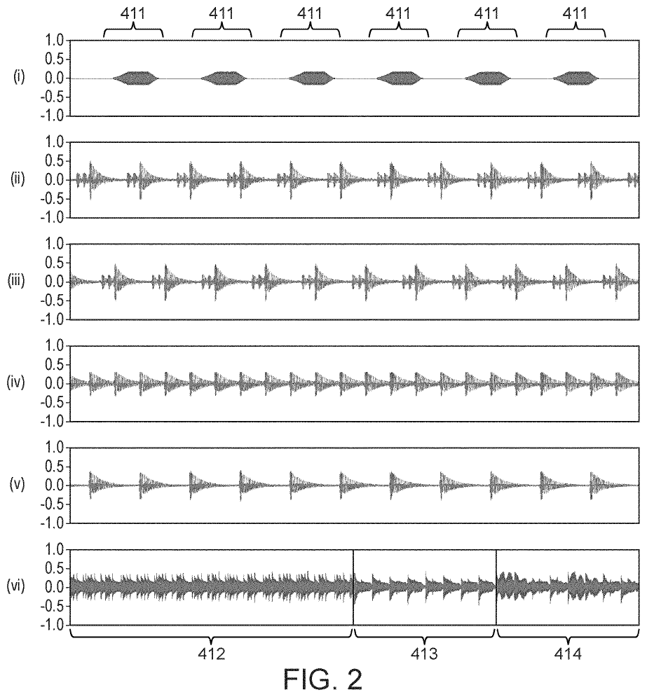

In certain embodiments the haptic signals 410a, 410b of the media track 317 include at least one repeating pattern of at least one pulse. That is, the haptic signals 410a, 410b may include a repeating pattern of changes in signal amplitude, that causes the corresponding haptic transducers 305a, 305b to output a repeating pattern of vibrations. By way of example, FIG. 2 illustrates six example haptic signals (i)-(vi), each including at least one repeating pattern of at least one pulse.

The repeating pattern may include any number or variety of pulses. For example, FIG. 2(i) shows a pattern 411 including a pulse that regularly repeats. FIGS. 2(iv) and 2(v) also show patterns including a pulse that regularly repeats. In such examples the envelope or shape of the single pulse is non-static. That is, the attack, decay, sustain, and release of the pulse are selected so as to provide variation within the pulse itself.

In other examples, the repeating pattern may include two pulses of differing amplitude and/or frequency or shape, for example FIG. 2(ii) and FIG. 2(iii). There may be variation of the pulse shape, amplitude, frequency or spacing within the repeating pattern of pulses. For example, the haptic signal in FIG. 2(i) clearly shows a repeating pattern of a pulse with a slow attack, a significant sustain and slow release amplitude envelope, while the haptic signal in FIG. 2(iv) clearly show a repeating pattern which seems percussive in nature (quick attack and medium long release). At least one pulse within the repeating pattern may be non-static.

Advantageously, the use of repeating patterns of at least one non-static pulse within the haptic signals has been found to stimulate a user, without providing a distraction. That is, using a repeating pattern with different amplitudes, frequencies and timings (rather than a single, static pulse repeated at regular timings) provides variation that avoids monotony. However, the use of repetition ensures the user is not distracted. As such, the occupant receives an improved audio and massage experience, without detriment to the occupant's concentration or cognitive ability.

The pattern of pulses may be repeated throughout the duration of the media track. However, for some haptic signals, the haptic signal may include a first repeating pattern of pulses followed by a second repeating pattern of pulses and optionally a third, fourth or fifth repeating pattern of pulses. For example, haptic signal (vi) of FIG. 2 includes three distinct sections 412, 413, 414, each section including a repeating pattern of pulses. That is the haptic signal (vi) includes a section 412 including a first repeating pattern followed subsequently by further sections 413 and 414 each including different repeating patterns.

Each repeating pattern of pulses may differ from the other repeating patterns of pulses, or at least may differ from the preceding and succeeding patterns of pulses in at least one of the frequency content and shape of the pulses; the amplitude of the pulses; the timing of the pulses; and the time between the pulses.

Advantageously, the use of multiple repeating patterns has been found to help ensure the media track does not feel too repetitive or monotonous to a user. That is, the change from a first repeating pattern to another repeating pattern provides additional stimulus to a user, which may be beneficial at a time when the users interest in the first repeating pattern is decreasing.

In certain embodiments, the haptic signals 410a, 410b and the audio signal 405 are configured so that the vibrations 425 emitted from the haptic transducers 305a, 305b are complimentary to the sound waves 415 emitted from the audio speaker 310. For example, the tempo of the audio signal 405 of the media track 317 may be the same as, or linked to, the tempo of the haptic signals 410a, 410b of the media track 317. For example, for an audio signal with a high tempo—that is, having a number of beats per minute equal or greater than 120 bpm—the tempo of the haptic signals 410a, 410b may also have a tempo of 120 bpm. As used herein, the ‘tempo’ of an audio or haptic signal refers to the speed of the signal when played through the audio speaker 310 or haptic transducers 305a, 305b. For example, at least one of the frequency content and shape of the pulses, the timing of the pulses and the time between the pulses in each haptic signal may have been selected so that the tempo of the haptic signals 410a, 410b matches that of the audio signal 405.

Alternatively, or in addition the rhythm or beat of the audio signal 405 of the media track 317 may be the same as, or linked to, the rhythm or beat of the haptic signals 410a, 410b of the media track 317. As used herein, the ‘rhythm’ of an audio or haptic signal refers to the rhythmical pattern of the signal in time when played through the audio speaker 310 and haptic transducers 305a, 305b. Similarly, the ‘beat’ of an audio or haptic signal refers to the general rhythmic feel of the signal when played through the audio speaker 310 and haptic transducers 305a, 305b. It would be understood that ‘tempo’, ‘beat’ and ‘rhythm’ are closely related terms.

For example, at least one of the frequency content and shape of the pulses, the amplitude of the pulses, the timing of the pulses and the time between the pulses in each haptic signal may have been selected so that the pattern of, or the general rhythmic feel of, the signal of the haptic signals 410a, 410b matched or is in accordance with that of the audio signal 405. As an example, at least part of the haptic signals 410a, 410b may be homophonic with the audio signal 405. As an example, at least part of the haptic signals 410a, 410b may be in time with the audio signal 405. As an example, for at least part of the haptic signals 410a, 410b a relative change in the pulse frequency and/or amplitude and/or spacing may correspond to (i.e. occur at the same time as) a relative change in the pulse frequency and/or amplitude and/or spacing of the audio signal 405.

Advantageously, providing similarities in the signal characteristics (for example tempo, rhythm, beat) of the audio and haptic signals has been found to help ensure the audio and haptic stimulus work in concert. That is, the haptic sensations complement the audio stimulus so that the media track provides a single, but multi-faceted, experience to the user. This ensures the media track is not distracting to a user and they instead feel immersed within the track.

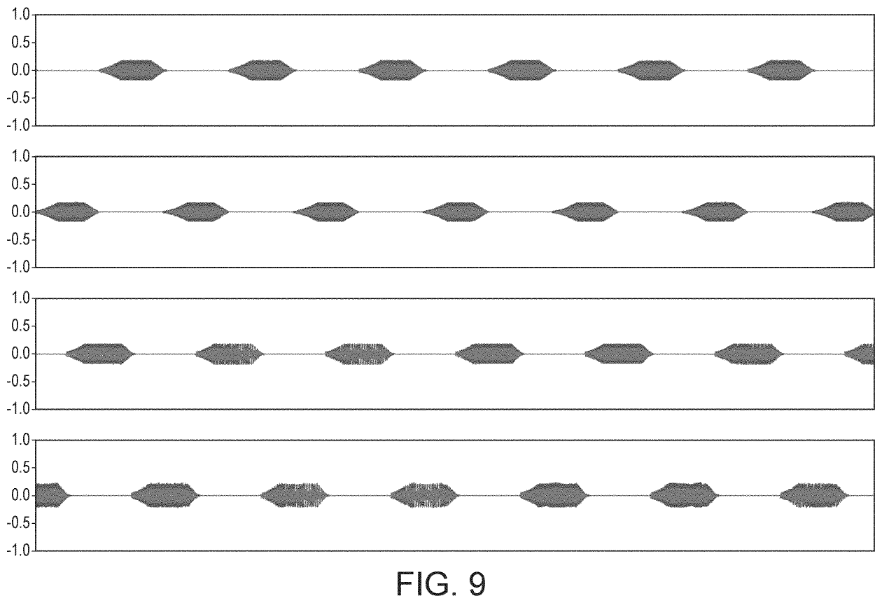

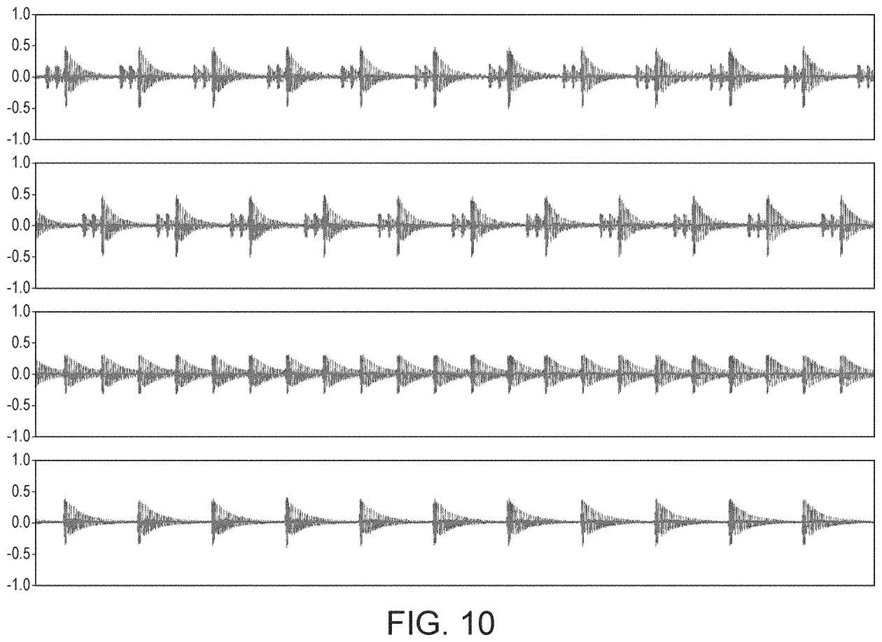

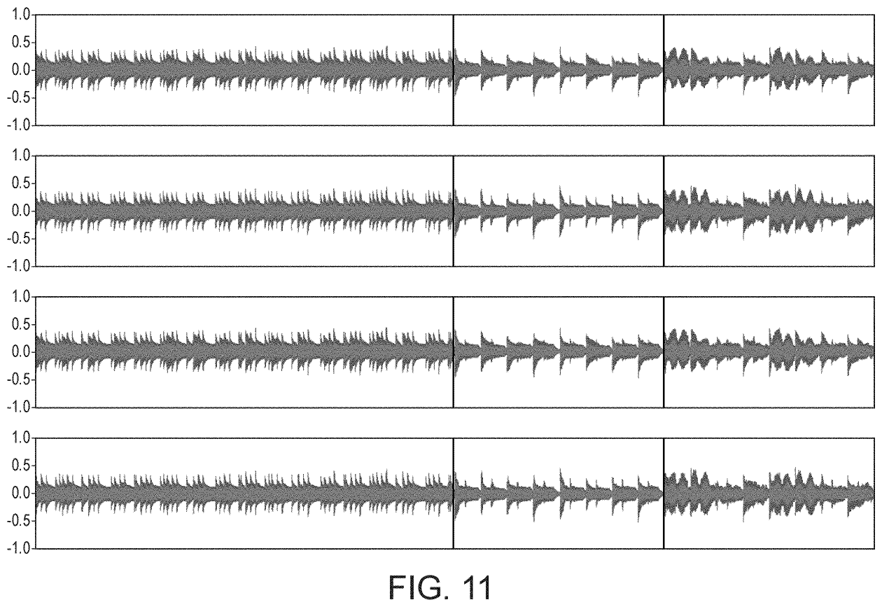

It would be understood that the haptic signals 410a, 410b may each be the same. For example, FIG. 11 illustrates a set of four haptic signals, each for driving a separate haptic transducer. Each signal is largely the same. However, in other examples, such as those illustrated in FIGS. 9 and 10 described below, each haptic transducer may be driven with a different haptic signal.

In certain embodiments, the vehicle haptic system 100 comprises input means 325 for receiving an input from a user of the vehicle haptic system 100. The input means 325 may include a user-interface suitable for an occupant 2000 inputting instructions, such that the instructions form the input. The input means 325 is in communication with the control system 315. On receiving an input from a user of the vehicle haptic system 100, the input means 325 is configured to send an input signal 420 to the control system 315.

In certain embodiments on receiving an input signal 420 from the input means 325, the control system 315 is configured to adjust the audio signal 405 and/or the haptic signals 410a, 410b. Advantageously, this allows the user to adjust the output of the media track to suit personal preference.

For example either or both of the haptic signals 410a, 410b may be adjusted in amplitude or intensity. Further, either or both of the haptic signals 410a, 410b may be paused, muted, or stopped. Similarly, the audio signal 405 may be adjusted in amplitude or intensity. Further, the audio signal 405 may be paused, muted, or stopped. The haptic signals 410a, 410b and the audio signal 405 may be adjusted together. The memory 316 may further store the instructions of how the haptic signals 410a, 410b and/or the audio signals 405 have been adjusted, such that adjustments made to the haptic signals 410a, 410b and/or audio signals 405 are retained between ignition cycles of the vehicle 1000.

In certain embodiments a plurality of media tracks 317 are stored in the memory 316, each of the plurality of media tracks 317 including an audio signal 405 to drive the audio speaker 310 and haptic signals 410a, 410b to drive the haptic transducers 305a, 305b.

When the input signal 420 received from the input means 325 relates to the selection of a media track of the plurality of media tracks, the control system 315 is configured to retrieve the selected media track from the memory 316.

In response, the control system 315 then causes the audio speaker 310 to convert the audio signal(s) of the selected media track to sound waves, and causes the haptic transducers 305a, 305b to vibrate according to the haptic signal(s) of the selected media track.

That is, the memory 316 stores a library of media tracks, with a user able to select a particular media track from the library. Each media track 317 may have different characteristics. For example, each media track 317 may have a different tempo. For example, a first track may have a tempo of about 60-65 bpm, a second track may have a tempo of about 85-100 bpm and a third track may have a tempo of about 120-140 bpm. Other characteristics of the track may also differ from track to track.

As such, the user is provided with a library of tracks that may each invoke a different physiological and cognitive response from the resulting stimulus. For example, a higher tempo track may be used to invigorate a user, whereas a lower tempo track may be used to relax a user. In this sense, the mood of a user may be changed or reinforced depending on the chosen track.

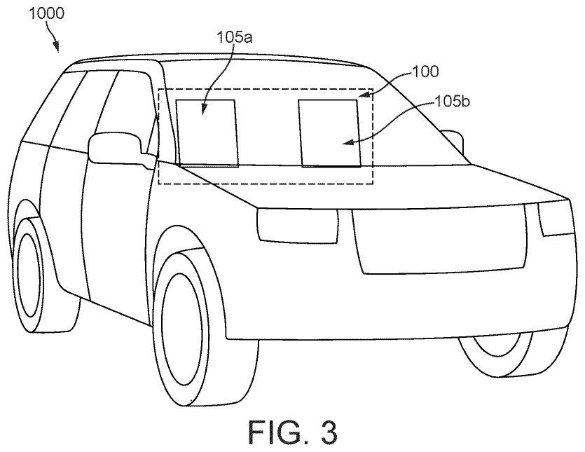

FIG. 3 illustrates a vehicle haptic system 100 installed in a vehicle 1000. In this example the vehicle haptic system 100 includes at least one vehicle seat 105. Two vehicle seats 105a, 105b are evident in FIG. 3 but the vehicle haptic system 100 may include any number of vehicle seats 105, for example one, two, three, or more vehicle seats 105. The vehicle 1000 in the present embodiment is an automobile, such as a wheeled vehicle, but it will be understood that the vehicle haptic system 100 may be used in other types of vehicle.

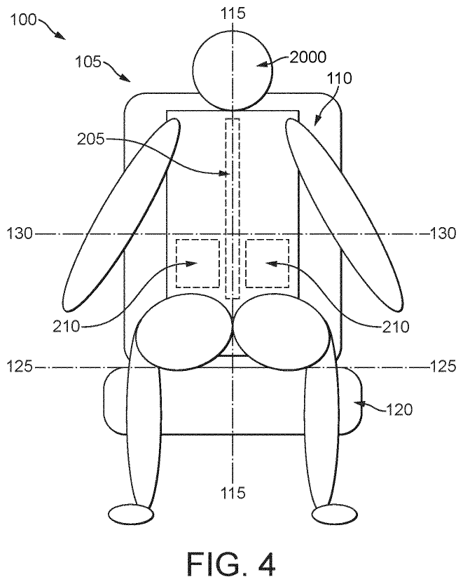

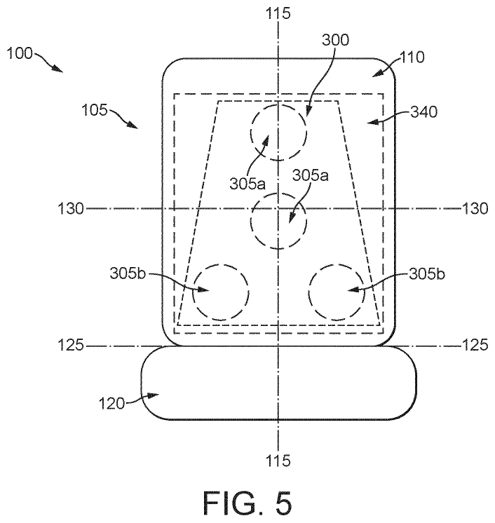

Referring to FIGS. 4 and 5, the vehicle seat 105 includes a backrest portion 110 for supporting an occupant 2000 of the vehicle seat 105, and more specifically for supporting the back of an occupant 2000. The occupant 2000 may be a driver of the vehicle 1000, or a passenger of the vehicle 1000. The vehicle seat 105 includes a base portion 120 for further supporting the buttocks and legs of the occupant 2000. The base portion 120 is joined to the backrest portion 110 at approximately a 90-degree angle, however, this angle may be configurable by the occupant 2000.

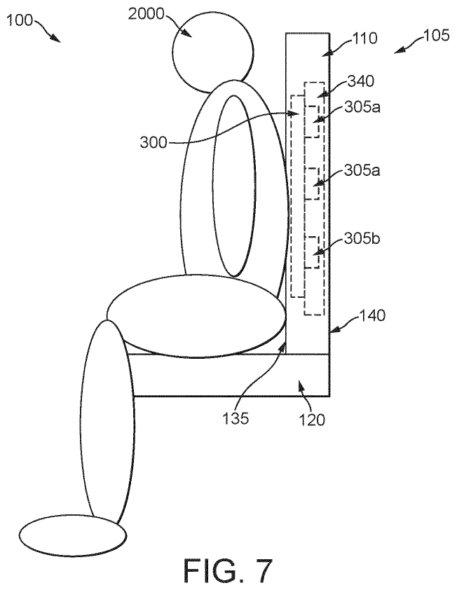

Referring to FIGS. 5, 6 and 7, the haptic transducers 305a, 305b are disposed on, or disposed within, the backrest portion 110 of the vehicle seat 105.

In this example, the at least one haptic transducer includes at least two sets of haptic transducers—a first set of at least one haptic transducer 305a and a second set of at least one haptic transducer 305b. In the illustrated examples, each of the first set and the second set includes two haptic transducers. However, in other examples the first set and the second set of haptic transducers 305a, 305b may include one, three or more haptic transducers.

The backrest portion 110 includes a central, longitudinal, axis 115, which splits or bisects the backrest portion 110 into two substantially equal longitudinal sections—a first section and a second section. The first section may be laterally offset from the central, longitudinal, axis 115 in a first direction, and the second section may be laterally offset from the central, longitudinal, axis 115 in a second direction, opposite to the first direction.

The haptic transducers 305a of the first set are disposed along the central, longitudinal, axis 115 of the backrest 110. The haptic transducers 305a may be disposed in any location along the central, longitudinal, axis 115 of the backrest portion 110. For example, the first set may include a first haptic transducer 305a disposed in an upper section of the backrest portion 110 and a second haptic transducer 305a disposed in a lower section of the backrest portion 110, with both haptic transducers 305a being disposed along the central, longitudinal, axis 115. Aptly, the first haptic transducer 305a and the second haptic transducer 305a of the first set may be longitudinally offset along the central, longitudinal, axis 115 of the backrest portion 110 by a distance in the range of 100 to 200 mm, aptly 120 to 140 mm.

As shown in FIG. 4, when an occupant 2000 is sat in the vehicle seat 105, the central, longitudinal, axis 115 of the backrest portion 110 aligns with a spinal region 205 of the occupant 2000. As used herein, the spinal region 205 of an occupant 2000 refers to a region disposed along a central, longitudinal, axis of the back of the occupant 2000. As such, when actuated, the haptic transducers 305a of the first set are positioned to vibrate at least the spinal region 205 of the occupant 2000 of the vehicle seat 105, in use. In doing so, the vibrations emitted by the haptic transducers 305a of the first set provide the spinal region 205 of an occupant 2000 with tactile feedback, or a massage sensation. Positioning haptic transducers 305a in this way is advantageous, in that the spinal region 205 of an occupant 2000 is particularly sensitive to vibrations. As such, the occupant's 2000 perception of bass frequencies emitted by the haptic transducers 305a of the first set is maximised.

The haptic transducers 305b of the second set are each disposed in a position laterally offset from the central, longitudinal, axis 115 of the backrest portion 110. As used herein, a position laterally offset of the central, longitudinal, axis 115 of the backrest portion 110 refers to position offset in a direction substantially left or right of the central, longitudinal, axis 115. That is, the haptic transducers 305b of the second set are positioned in the first or second section of the backrest portion 110, as described above. In the illustrated example, the haptic transducers 305b of the second set are disposed on either side (i.e., left and right) of the central, longitudinal, axis 115. That is, the second set includes a first haptic transducer 305b laterally offset from the central, longitudinal, axis 115 of the backrest portion 110 in a first direction, and a second haptic transducer 305b laterally offset from the central, longitudinal, axis 115 of the backrest portion in a second direction, opposite to the first direction. The haptic transducers 305b of the second set are disposed at the same height along the central, longitudinal, axis 115 of the backrest portion 110, such that the haptic transducers 305b are mirrored in location when viewed in relation to the central, longitudinal, axis 115 of the backrest portion 110. Further, the haptic transducers 305b of the second set may be disposed an equal distance away from the central, longitudinal, axis 115 in the first and second directions respectively. Aptly, the first haptic transducer 305b and the second haptic transducer 305b of the second set may be laterally offset from the central, longitudinal, axis 115 of the backrest portion 110 by a distance in the range of 80 to 100 mm in the first and second directions respectively. The backrest portion 110 further includes a base 125, and a transverse axis 130. The base 125 of the backrest portion 110 is located at the point of intersection between the backrest portion 110 and the base portion 120. The transverse axis 130 bisects the backrest portion 110, such that the transverse axis 130 splits the backrest portion 110 into a substantially upper section and a lower section. In this example, the haptic transducers 305b of the second set are disposed in a position between the base 125 of the backrest portion 110, and the transverse axis 130 that bisects the backrest portion 110, i.e., in the lower section of the backrest portion 110. With this position, the at least one haptic transducers 305b of the second set are positioned so to vibrate a kidney region 210 of an occupant 2000 of the at least one vehicle seat 105 in use. That is, when an occupant 2000 is sat in the at least one vehicle seat 105, the haptic transducers 305b of the second set are generally aligned with, or proximal to, a corresponding kidney region 210 of the occupant 2000 of the at least vehicle seat 105. As used herein, the kidney regions 210 of an occupant 2000 refer to regions being disposed in the lower back area of the occupant 2000, more specifically side portions of the lower back area. Thereby, the haptic transducers 305b of the second set are disposed in positions to vibrate the kidney regions 210 of the occupant 2000 of the at least vehicle seat 105 in use. The vibrations emitted by the haptic transducers 305b of the second set are configured to provide the kidney regions 210 of an occupant 2000 with tactile feedback, or a massage sensation. Positioning haptic transducers 305b in this way is advantageous in that the kidney regions 210 of an occupant 2000 are particularly sensitive to vibrations. As such, the occupant's 2000 perception of bass frequencies emitted by the haptic transducers 305b of the second set is maximised.

Aptly, the haptic transducers 305 b of the second set may be disposed at a distance in the range of 20 to 40 mm above the base 125 of the backrest portion 110. Further, aptly, the second haptic transducer 305a of the first set may be disposed at a distance in the range of 100 to 140 mm above the base 125 of the backrest portion 110.

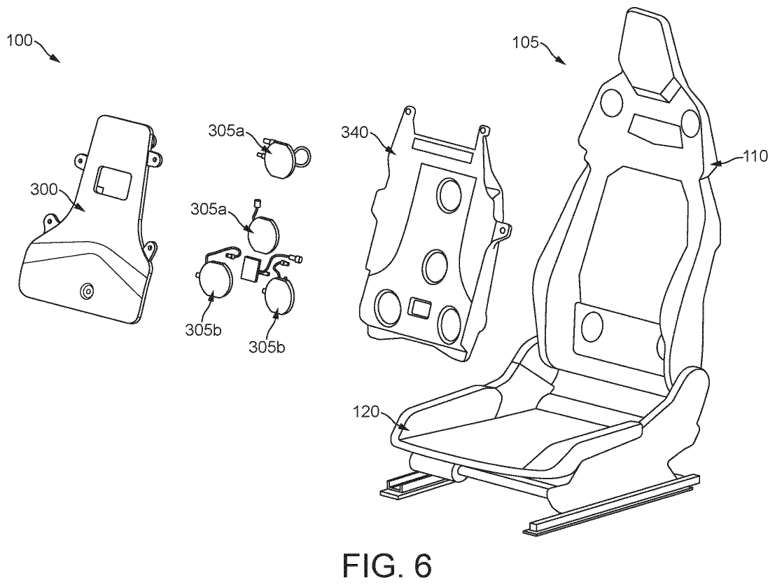

FIGS. 5, 6 and 7 illustrate an example assembly including the backrest portion 110, the first set of haptic transducers 305a and the second set of haptic transducers 305b. In FIG. 6 a frame structure of the backrest portion 110 is shown. The backrest portion 110 includes a mounting frame 340, positioned within the frame structure of the backrest portion 110. The haptic transducers 305a of the first set and the haptic transducers 305b of the second set are mounted on the mounting frame 340. The haptic transducers 305a, 305b may be mounted on the mounting frame 340 in any suitable manner. In this example, the mounting frame 340 includes recesses for receiving each haptic transducer 305a, 305b. Further components of the vehicle haptic system 100 described herein, for example the amplifier 320 or the audio speaker 310, may also be mounted to the mounting frame 340. The mounting frame 340 may in turn be securely attached to the frame structure of the backrest portion 110 by way of screws, or other fixing components. Advantageously, the mounting frame 340 provides a single point of attachment for multiple components to the backrest portion 110, for example the haptic transducers 305a of the first set and the haptic transducers 305b of the second set, thereby improving the efficiency of the assembling the vehicle haptic system 100.

In this example the control system 315 is configured to independently control the haptic transducers 305a of the first set and the haptic transducers 305b of the second set. That is, separate signals can be sent to the transducers of each set. Further, the control system 315 may be configured to pass separate haptic signals to haptic transducers within each set.

As noted above, each media track 317 may include a first haptic signal 410a to drive a first haptic transducer 305a and a second haptic signal 410b to drive a second haptic transducer 305b. In this example the first haptic signal 410a is used to drive the haptic transducers 305a of the first set and the second haptic signal 410b is used to drive the haptic transducers 305b of the second set. In certain embodiments, each media track may include a separate haptic signal for each haptic transducer of each of the first and second sets. Advantageously, emitting different vibrations from the haptic transducers within each set can provide an occupant 2000 with a more transient experience.

By providing different haptic signals to each of the first and second set of haptic transducers, the spinal region 205 and kidney region 210 can be activated differently by the haptic transducers. That is, haptic signals can be sent to the first set of haptic transducers 305a so that the spinal region 205 is vibrated at a frequency, amplitude or tempo to which it is particularly sensitive. Similarly, the kidney region 210 can be vibrated at a frequency, amplitude or temp to which it is particularly sensitive. For example, the first haptic signal may produce vibrations having a waveform that is substantially sharper or more transient than the second signal. The first haptic signal may include frequencies in the range of 60 to 200 Hz, aptly the first haptic signal may include frequencies in the range of 60 to 150 Hz. The second haptic signal may include frequencies in the range of 20 to 70 Hz, aptly 25 to 70 Hz.

Advantageously, the at least one vehicle seat 105 may spread vibrations produced by the haptic transducers of the second set 305b from the backrest portion 110 to the base portion 120. Thereby, the at least one haptic transducer of the second 305b set vibrate buttocks and legs of an occupant 2000 of the at least one vehicle seat 105 in use, in addition to the kidney regions 210 of the occupant 2000. As such, the vehicle haptic system 100 therefore does not require additional haptic transducers to vibrate the buttocks and legs of an occupant 2000. Advantageously, the frequencies to which the kidney region 210 are particularly sensitive are also likely to spread to the base portion 120.

The backrest portion 110 of the vehicle seat 105 includes a spreader plate, for example a vibro-tactile membrane 300. The haptic transducers 305a of the first set and the haptic transducers 305b of the second set are affixed to the vibro-tactile membrane 300. That is, the haptic transducers 305a of the first set and the haptic transducers 305b of the second set are in direct contact with the vibro-tactile membrane 300. The vibro-tactile membrane 300 covers the haptic transducers 305a of the first set and the haptic transducers 305b of the second set. The vibro-tactile membrane 300 extends beyond the locations of each of the haptic transducers 305a, 305b so as to provide a surface for spreading the vibrations emitted from the haptic transducers 305a, 305b over the backrest portion 110, and in turn, to the occupant 2000. The vehicle seat 105 includes a front face 135, facing an occupant 2000 of the at least one vehicle seat 105, when in use, and a rear face 140, facing away from the occupant 2000, when in use. The vibro-tactile membrane 300 is positioned substantially towards the front face 135 of the vehicle seat 105, with the haptic transducers 305a of the first set and the haptic transducers 305b of the second set being affixed to the back of the vibro-tactile membrane 300, i.e., facing the rear face 140 of the vehicle seat 105. The vibro-tactile membrane 300 is then affixed to the mounting frame 340 by way of screws, or other fixing components.

The vibro-tactile membrane 300 may be manufactured from a polymer material, for example, a polyurethane (PU) foam. The polyurethane (PU) foam may be a high density closed-cell polyurethane (PU) foam, for example having a density of approximately 320 kgm⁻³. The vibro-tactile membrane 300 may have a thickness of approximately 3 mm.

Advantageously, spreading the vibrations produced by the haptic transducers 305a, 305b over the backrest portion 110 ensures the vehicle haptic system 100 is suitable for occupants 2000 of different physical sizes. That is, the spinal region 205 and kidney 210 regions can still be activated even in situations where the transducers 305a, 305b do not exactly align with these regions 205, 210. In addition, the vibro-tactile membrane 300 acts to spread (to some extent) the localised vibrations felt in the regions 205, 210 to provide the occupant 2000 with a more homogenised feeling.

The at least one vehicle seat 105 may include one or more insulating members disposed around at least one of the haptic transducers 305a, 305b. The insulating member may be disposed around substantially all faces of the haptic transducers 305a, 305b, apart from that which faces the back of the occupant 2000. The insulating member may include an insulating layer covering the face of each haptic transducer 305a, 305b that points to the rear face 140 of the vehicle seat 105. In an example, separate insulating layers are included for the haptic transducers of the first set 305a and the second set 305b.

Advantageously, the insulating member may prevent vibration losses by directing vibrations emitted from the haptic transducers 305a, 305b towards the back of an occupant 2000, when in use. This increases efficiency and prevents damage to other components that may not be suitable for receiving such vibrations.

The insulating member may include recesses for receiving each haptic transducer 305a, 305b. The insulating member may be manufactured from a polymer material, for example polyurethane (PU) foam, or any insulating material known in the art. Preferably, the polyurethane (PU) foam is low density (approximately 49 kgm⁻³) closed cell polyurethane (PU) foam. Where in contact with one of the haptic transducers 305a, 305b, the insulating member is at least 10 mm in thickness, and where not in contact with one of the haptic transducers 305a, 305b, the insulating member is 5 mm in thickness. The insulating member may be affixed to the vibro-tactile membrane 300 by way of adhesive strips, screws or other means known in the art.

The backrest portion 110 includes a material covering or upholstery, disposed between the vibro-tactile membrane 300 and the occupant 2000, such that the haptic transducers 305a of the first set and the haptic transducers 305b of the second set indirectly contact the occupant 2000 by way of the material covering or upholstery.

The material covering may include a cushioning material, provided for comfort, and a cover or liner, providing the exterior of the backrest portion 110. The cushioning material may be a foam. The thickness of the foam may be from 40 mm to 80 mm, aptly from 50 mm to 70 mm, aptly from 55 mm to 60 mm. Providing foam of this thickness, which is much greater than the thicknesses used in conventional vehicle sets (typically between 20 mm and 25 mm) ensures the haptic transducers 305a, 305b do not impact on the comfort of the occupant 2000. It would be understood that the thickness of the foam may not be homogenous across the backrest portion 110. Instead, the thickness of the foam may be greater in the areas covering the haptic transducers 305a, 305b.

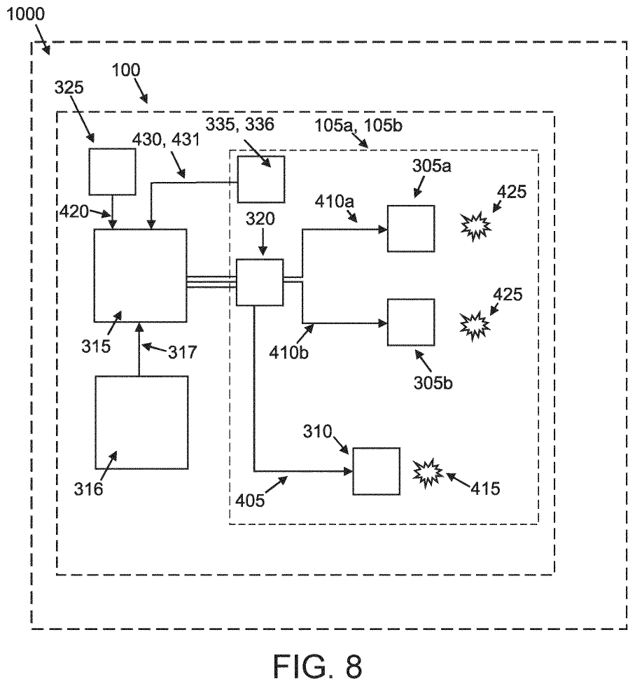

FIG. 8 illustrates an example of a vehicle haptic system 100 implemented within a vehicle 1000. The vehicle haptic system 100 has similarities to that shown in FIG. 1, with corresponding features having the same reference numeral.

In FIG. 8, the system 100 is shown with both a first vehicle seat 105a and a second vehicle seat 105b, each having the separate hardware—that is, each having haptic transducers 305a, 305b and an audio speaker 310. However, it will be noted that there may be shared hardware between the vehicle seats 105a, 105b. For example the audio speaker 310 may be common to both vehicle seats 105a, 105b. The occupant of each vehicle seat 105a, 105b may each choose to experience a different media track 317, for example with one using headphones as audio speaker 310 with the other using the main vehicle audio speakers as audio speaker 310.

The vehicle haptic system 100 shown in FIG. 8 further includes at least one pressure sensor 335, for example a pressure sensor 335 for each vehicle seat 105a, 105b.

The at least one pressure sensor may be disposed on the backrest portion 110, and/or the base portion 120, of the vehicle seat 105. The at least one pressure sensor is configured to measure pressure applied to the vehicle seat 105 and generate a pressure signal 430. The pressure applied to the at least one vehicle seat 105 is generated by the occupant 2000 seated on the base portion 120 and/or supported by the backrest portion 110, when in use.

The vehicle haptic system 100 may be configured so that the haptic transducers 305a, 305b cannot be actuated, or actuation is stopped, when the pressure signal is below a lower limit value. A pressure signal below a limit value may indicate that the occupant 2000 is no longer sat on the base portion 120 or has leaned forward from the backrest portion 110 so that they would no longer benefit from actuation of the haptic transducers 305a, 305b. The lower limit may be equal to the lowest weight of occupant 2000 expected to be sat in, or supported by, the at least one vehicle seat 105, as such, when there is no occupant 2000 in the at least one vehicle seat 105, the at least one haptic transducer 305a of the first set and the at least one haptic transducer 305b of the second set are not actuated. In this manner, the vehicle haptic system 100 may, advantageously, conserve power when an occupant 2000 is not seated in, or supported by, the at least one vehicle seat 105, thereby improving the efficiency of operating the vehicle haptic system 100. In addition, the experience of other vehicle occupants 2000 may be improved with the removal of background ‘noise’ from the haptic transducers 305a, 305b when not required.

Alternatively, the vehicle haptic system 100 may be configured so that the haptic transducers 305a, 305b cannot be actuated, or actuation is stopped, when other sensing means detect that the occupant 2000 is not seated on the base portion 120 and/or supported by the backrest portion 110 of the at least one vehicle seat 105. Other sensing means may include the use of camera, a motion sensor, or other means known in the art.

In the example of FIG. 8, the vehicle haptic system 100 further includes an amplifier 320 for amplifying haptic signals 410a, 410b and audio signals 405. It would be understood that there may be more than one amplifier, for example one for each vehicle seat 105a, 105b and/or one for each signal of the media track.

The control system 315 is coupled to haptic transducers 305a, 305b and audio speaker 310 via the amplifier 320, by any means described above or known in the art. The amplifier 320 may be disposed on the at least one vehicle seat 105, or in another location within the vehicle 1000, for example, a centre console of the vehicle 1000. The amplifier 320 may amplify the signals of the media track so that they are suitable to be received by the corresponding haptic transducers or audio speaker.

The vehicle haptic system 100 may include at least one sensor arrangement 336 configured to measure physiological parameters regarding a user of the vehicle haptic system 100 and generate a sensor signal 431. The sensor arrangement may include one or more of a heart rate sensor and a galvanic skin response sensor. As shown in FIG. 8, the sensor arrangement 336 is in communication with the control system 315, such that the control system 315 is configured to receive the sensor signal 431 from the at least one sensor arrangement 336.

In response to the sensor signal 431 indicating a physiological parameter of the user of the vehicle haptic system 100 is above an upper threshold or below a lower threshold, the control system 315 may be configured to adjust the audio signal 405 and/or the haptic signals 410a, 410b of the media track currently being played. For example, if the measured physiological parameter indicates that a user is drowsy, for example their heart rate has dropped below a threshold, the control system 315 may adjust the signals so that the user is more engaged and alert. For example the signal intensity may be increased or the tempo may be increased. Similarly, if the measured physiological parameter indicates that a user is stressed, for example their heart rate has risen above a threshold, the control system 315 may adjust the signals so that the user is more relaxed.

In response to the sensor signal 431 indicating a physiological parameter of the user of the vehicle haptic system 100 is above an upper threshold or below a lower threshold, the control system 315 is configured to retrieve another media track of the plurality of media tracks from the memory. For example, the control system 315 may select a media track that is configured to be more relaxing if a physiological parameter of the user indicates that the user is stressed. The control system 315 may change the media track 317 without input from the user or the control system 315 may send a notification signal to a user interface of the vehicle haptic system 100, the notification signal suggesting the selection of another media track of the plurality of media tracks from the memory 316.

FIGS. 9 to 11 illustrate examples of haptic signals for a vehicle haptic system. In particular, each of FIGS. 9 to 11 illustrates a group of four haptic signals, each for driving a respective haptic transducer, for example the haptic transducers 305a of the first set and the haptic transducers 305b of the second set. For the haptic signals of FIGS. 9 and 10, each of the four haptic signals is distinct. However, it would be understood that the same haptic signal may be sent to each haptic transducer within the first set and the same haptic signal may be sent to each haptic transducer within the second set. The repeating pattern of pulses of the different haptic signals may differ in at least one of the frequency content and shape of the pulses; the amplitude of the pulses; the timing of the pulses; and the frequency of (i.e. spacing between) the pulses.

FIG. 12 illustrates an example control system, for example control system 315 as described above. In this example the control system 315 comprises one controller 3151, although it will be appreciated that this is merely illustrative. The controller 3151 comprises processing means 3152 and memory means 3153. The processing means 3152 may be one or more electronic processing device 3152 which operably executes computer-readable instructions. The memory means 3153 may be one or more memory device 3153. The memory means 3153 is electrically coupled to the processing means 3152. The memory means 3153 is configured to store instructions. The memory means 3153 may also store one or more media tracks including audio signals and haptic signals in the manner described above. The processing means 3152 is configured to access the memory means 3153 and execute the instructions stored thereon.

The controller 3151 comprises an input means 3154 and an output means 3155. The input means 3154 may comprise an electrical input 3154 of the controller 3151. The output means 3155 may comprise an electrical output 3155 of the controller 3151. The input 3154 is arranged to receive any of a signals forming a media track, an input signal 420 or a pressure signal 430 as described above. The output 3155 is arranged to output any of an audio signal 405, or a haptic signal 410, as described above.

A method of controlling the vehicle haptic system 100 in any of ways described above may be performed by the control system 315 illustrated in FIG. 12. In particular, the memory 3153 may comprise computer-readable instructions which, when executed by the processor 3152, perform the method according to an embodiment of the invention.

It will be appreciated that various changes and modifications can be made to the present invention without departing from the scope of the present application. For example, it would be understood that the vehicle haptic system 100 would be operable without the vibro-tactile membrane 300. Further, aspects of the vehicle haptic system 100 described in FIG. 8 may be omitted—for example the input means 325, the pressure sensor 335, the sensor arrangement 336, the amplifier 320 or a vehicle seat.

In some examples, the vehicle haptic system 100 may include at least one of a lighting system and a fragrance system. Each media track may include an actuation signal for each of these system so that the control system is configured to actuate the lighting system or fragrance system according to the actuation signals of each media track. The lighting and fragrance can complement the intended effect of the media track upon the user. For example, soft lighting and particular fragrances may be used to emphasise the relaxing effect of a low tempo media track on a user.

In some examples, the at least one haptic transducer may be located in the base portion 120 of the vehicle 105. In some examples. The at least one haptic transducer may be located in, or be part of, a foot haptic module in a footrest or floor portion of a vehicle. For example, the at least one haptic transducer may include a first set of at least one haptic transducer for vibrating a first foot of the user of the vehicle haptic system; and a second set of at least one haptic transducer for vibrating a second foot of the user of the vehicle haptic system. The foot haptic module may have a profile having a length and a width, wherein the first set of at least one haptic transducer is offset from the second set of at least one haptic transducer along the length and/or the width of the profile of the at least one foot haptic module.

In some examples, the at least one haptic transducer may include haptic transducers in one or more of the backrest portion 110, the base portion 120 and the foot haptic module.

1. A vehicle haptic system for vibrating a body part of an occupant of a vehicle, the vehicle haptic system comprising:
at least one audio speaker for converting an audio signal to sound waves;
at least one haptic transducer for generating a vibration according to a haptic signal;
a memory storing at least one media track, the at least one media track comprising:
at least one audio signal to drive the at least one audio speaker; and
at least one haptic signal to drive the at least one haptic transducer; and
a control system in communication with the at least one audio speaker and the at least one haptic transducer, and configured to cause the at least one audio speaker to convert the at least one audio signal to sound waves, and cause the at least one haptic transducer to vibrate according to the at least one haptic signal.

2. The vehicle haptic system of claim 1, wherein the at least one haptic signal of the at least one media track comprises at least one repeating pattern of at least one pulse.

3. The vehicle haptic system of claim 2, wherein the at least one haptic signal of the at least one media track comprises a first repeating pattern of at least one pulse followed by a second repeating pattern of at least one pulse.

4. The vehicle haptic system of claim 3, wherein the first repeating pattern of at least one pulse differs from the second repeating pattern of at least one pulse in at least one of:
the shape of the at least one pulse;
the frequency of the at least one pulse;
the amplitude of the at least one pulse;
the timing of the at least one pulse; and
the time between successive pulses of the at least one pulse.

5. The vehicle haptic system of claim 1, wherein the tempo of the at least one audio signal of the at least one media track is the same as, or linked to, the tempo of the at least one haptic signal of the at least one media track.

6. The vehicle haptic system of claim 1, wherein the at least one haptic signal of the at least one media track comprises a first haptic signal to drive a first haptic transducer of the at least one haptic transducer and a second haptic signal to drive a second haptic transducer of the at least one haptic transducer.

7. The vehicle haptic system of claim 6, wherein the first haptic signal comprises at least one repeating pattern of at least one pulse, and wherein the second haptic signal comprises at least one repeating pattern of at least one pulse, wherein, at a corresponding time for each of the first haptic signal and the second haptic signal, the at least one repeating pattern of at least one pulse of the first haptic signal differs from the at least one repeating pattern of at least one pulse of the second haptic signal in at least one of:
the shape of the at least one pulse;
the frequency of the at least one pulse;
the amplitude of the at least one pulse;
the timing of the at least one pulse; and
the spacing between successive pulses of the at least one pulse.

8. The vehicle haptic system of claim 1, comprising at least one sensor arrangement configured to measure physiological parameters regarding a user of the vehicle haptic system and generate a sensor signal, and
wherein the control system is configured to receive the sensor signal from the at least one sensor arrangement.

9. The vehicle haptic system of claim 8, wherein in response to the sensor signal indicating a physiological parameter of the user of the vehicle haptic system is above an upper threshold or below a lower threshold, the control system is configured to adjust the at least one audio signal and/or the at least one haptic signal.

10. The vehicle haptic system of claim 1, wherein the memory is storing a plurality of media tracks, each of the plurality of media tracks comprising:
at least one audio signal to drive the at least one audio speaker; and
at least one haptic signal to drive the at least one haptic transducer,
wherein the vehicle haptic system comprises input means for receiving an input from a user of the vehicle haptic system,
wherein on receiving an input from a user of the vehicle haptic system, the input means is configured to send an input signal to the control system,
wherein on receiving an input signal from the input means selecting a media track of the plurality of media tracks, the control system is configured to retrieve the selected media track from the memory.

11. The vehicle haptic system of claim 10, wherein a first media track of the plurality of media tracks comprises a first tempo and a second media track of the plurality of media tracks comprises a second tempo.

12. The vehicle haptic system of claim 10, wherein on receiving an input signal from the input means, the control system is configured to adjust the at least one audio signal and/or the at least one haptic signal.

13. The vehicle haptic system of claim 1, comprising at least one vehicle seat comprising a backrest portion for supporting the user of the vehicle haptic system, wherein the at last one haptic transducer is disposed on the backrest portion.

14. The vehicle haptic system of claim 13, wherein the at least one haptic transducer comprises:
a first set of at least one haptic transducer disposed along a central, longitudinal, axis of the backrest portion; and
a second set of at least one haptic transducer disposed in a position laterally offset from the central, longitudinal, axis of the backrest portion.

15. A vehicle comprising the vehicle haptic system of claim 1.

16. The vehicle haptic system of claim 6 wherein the first haptic signal comprises a frequency range of from 60 to 150 Hz, and the second haptic signal comprises a frequency range of from 25 to 70 Hz.

17. The vehicle haptic system of claim 13 wherein the at least one haptic transducer of the first set is positioned so as to vibrate a spinal region of the user of the vehicle haptic system, in use, and
wherein the at least one haptic transducer of the second set is positioned so as to vibrate a kidney region of the user of the vehicle haptic system, in use.
